(19) United States
(12) Patent Application Publication
(10) Pub. No.: US 2012/0187079 A1
(43) Pub. Date: Jul. 26, 2012

(54) METHOD FOR MANUFACTURING A MAGNETIC SENSOR HAVING A FLAT UPPER SHIELD

(75) Inventors: Hideki Mashima, Hiratsuka-shi (JP); Nobuo Yoshida, Hiratsuka-shi (JP)

(73) Assignee: Hitachi Global Storage Technologies Netherlands B.V., Amsterdam (NL)

(21) Appl. No.: 13/010,908

(22) Filed: Jan. 21, 2011

(51) Int. Cl. G11B 5/127; C23F 1/00

(52) U.S. Cl. 216/22

(57) ABSTRACT

A method for manufacturing a magnetic sensor that has a flat upper shield. A sensor stack is formed with a sensor capping layer at its top and a first CMP stop layer over the sensor capping layer and a mask formed over the CMP stop layer. A hard bias layer and second CMP stop layer are deposited over the sensor stack, capping layer, first CMP stop layer and mask. A chemical mechanical polishing process is then performed to remove the mask, leaving a portion of the hard bias layer exposed between the first and second CMP stop layers. An ion milling is then performed to etch back the exposed portions of the hard magnetic bias layer. A reactive ion etching is then performed to remove the remaining first and second CMP top layers. An upper shield can then be formed on a substantially flat surface.

### FIELD OF THE INVENTION

The present invention relates to magnetoresistive sensors and more particularly to a method for manufacturing a sensor that produces a flat upper shield.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension aim to place the read and write heads over selected circular tracks on the rotating disk. The read and write heads are directly located on a slider that has an air bearing surface (ABS). The suspension arm biases the slider into contact with the surface of the disk when the disk is not rotating, but when the disk rotates air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes at least one coil, a write pole and one or more return poles. When a current flows through the coil, a resulting magnetic field causes a magnetic flux to flow through the write pole, which results in a magnetic write field emitting from the tip of the write pole. This magnetic field is sufficiently strong that it locally magnetizes a portion of the adjacent magnetic disk, thereby recording a bit of data. The write field, then, travels through a magnetically soft under-layer of the magnetic medium to return to the return pole of the write head.

A magnetoresistive sensor such as a Giant Magnetoresistive (GMR) sensor, or a Tunnel Junction Magnetoresisive (TMR) sensor can be employed to read a magnetic signal from the magnetic media. The sensor includes a nonmagnetic conductive layer (if the sensor is a GMR sensor) or a thin nonmagnetic, electrically insulating barrier layer (if the sensor is a TMR sensor) sandwiched between first and second ferromagnetic layers, hereinafter referred to as a pinned layer and a free layer. Magnetic shields are positioned above and below the sensor stack and can also serve as first and second electrical leads so that the electrical current travels perpendicularly to the plane of the free layer, spacer layer and pinned layer (current perpendicular to the plane (CPP) mode of operation). The magnetization direction of the pinned layer is pinned perpendicular to the air bearing surface (ABS) and the magnetization direction of the free layer is located parallel to the ABS, but free to rotate in response to external magnetic fields. The magnetization of the pinned layer is typically pinned by exchange coupling with an antiferromagnetic layer.

When the magnetizations of the pinned and free layers are parallel with respect to one another, scattering of the conduction electrons is minimized and when the magnetizations of the pinned and free layer are antiparallel, scattering is maximized. In a read mode the resistance of the spin valve sensor changes about linearly with the magnitudes of the magnetic fields from the rotating disk. When a sense current is conducted through the spin valve sensor, resistance changes cause potential changes that are detected and processed as playback signals.

In order to maximize data density it is necessary minimize magnetic bit length. With regard to a magnetic sensor, this means minimizing the gap thickness of the sensor, which is defined by the magnetic spacing between the upper and lower magnetic shields. To manufacture a sensor having a well controlled small gap thickness it would also be desirable to construct an upper shield having a flat bottom surface. Unfortunately, current manufacturing processes used to construct magnetic sensors have resulted in upper shields having poorly defined bottom surfaces and have limited the ability to produce a sensor having a small, well defined gap thickness.

### SUMMARY OF THE INVENTION

The present invention provides a method for manufacturing a magnetic sensor that has a flat upper shield. The method includes depositing a plurality of sensor layers over a bottom shield, depositing a first CMP stop layer over the plurality of sensor layers and forming a mask structure over the CMP stop layer. The image of the mask structure is transferred onto the CMP stop layer and the images of the mask and CMP stop layer are transferred onto the underlying plurality of sensor layers. A hard bias layer and a second CMP stop layer are then deposited. A chemical mechanical polishing is then performed to remove the mask. This leaves a portion of the hard bias layer exposed between the first and second CMP stop layers. An ion milling is performed to etch back these exposed portions of the hard bias layer. A reactive ion etching is then performed to remove the first and second CMP stop layers. A flat upper magnetic shield can then be formed, because the second ion milling has removed what would have been upward extending peaks between where the first and second CMP stop layers had been located.

A sensor capping layer can be formed at the top of the plurality of sensor layers just beneath the first CMP stop layer. This capping layer can have an upper surface, and the second ion milling can be performed sufficiently to form the exposed portion of the hard bias layer with a recessed surface that is substantially coplanar with the upper surface of the capping layer. In addition, a hard bias capping layer can be formed over the hard bias layer.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is an ABS view of an example of a magnetoresistive sensor that might be constructed by a method of the present invention;

FIGS. 4-9 are views of a magnetic sensor in various intermediate stages of manufacture, illustrating a prior art method for manufacturing a magnetic sensor; and

FIGS. 10-17 are views of a magnetic sensor in various intermediate stages of manufacture, illustrating a method for manufacturing a magnetic sensor according to an embodiment of the invention.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

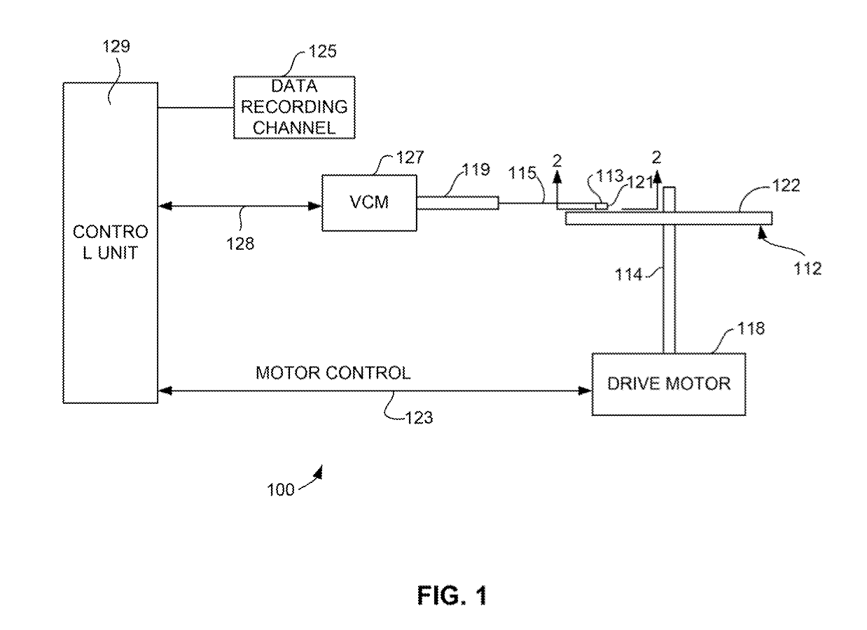

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

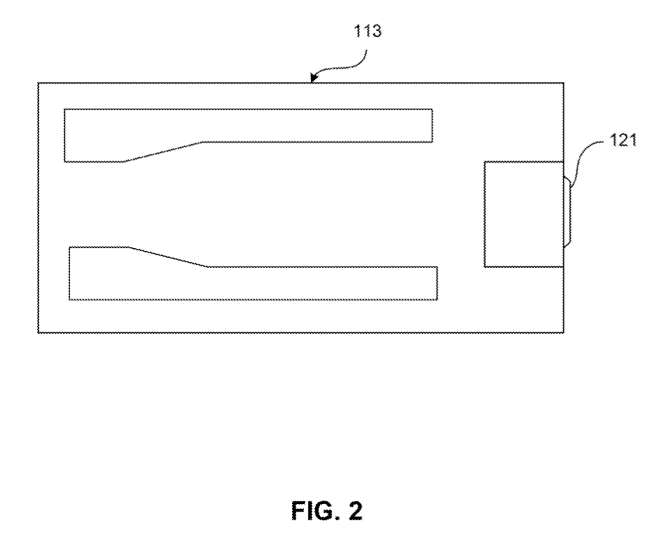

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

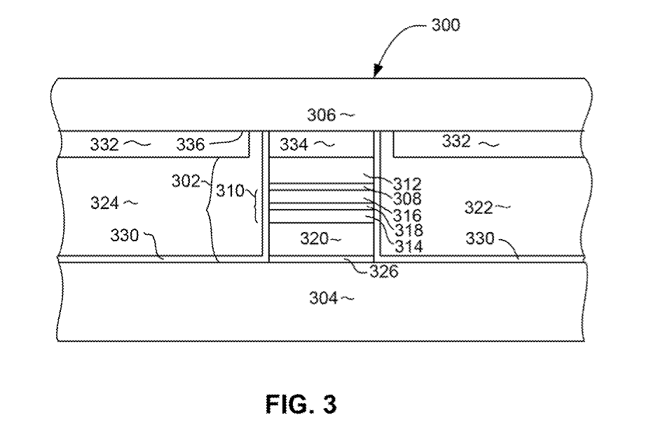

FIG. 3 shows an example of a magnetoresistive sensor structure 300 that could be constructed according to a method of the present invention. The sensor structure 300 is seen as viewed from the air bearing surface (ABS). The sensor 300 includes a sensor stack 302 that is sandwiched between first and second, electrically conductive, magnetic shields 304, 306 that also function as electrically conductive leads.

The sensor stack 302 can include a non-magnetic layer 308 that is sandwiched between a magnetic pinned layer structure 310 and a magnetic free layer structure 312. The non-magnetic layer 308 can be an electrically conductive material, if the sensor 300 is a Giant Magnetoresistive (GMR) sensor, and can be a thin electrically insulating material layer if the sensor structure 300 is a Tunnel Junction Sensor (TMR).

The pinned layer structure 310 can include first and second magnetic layers 314, 316 with a non-magnetic, antiparallel coupling layer such as Ru 318 sandwiched between the first and second magnetic layers 314, 318. The first magnetic layer 314 has its magnetization pinned in a first direction perpendicular to the ABS. This pinning is a result of exchange coupling with a layer of antiferromagnetic material 320 such as IrMn. The second magnetic layer 316 has its magnetization pinned in a second direction that is antiparallel with the first direction as a result of antiparallel coupling between the first and second magnetic layers 314, 316 across the antiparallel coupling layer 318.

The magnetic free layer 312 has a magnetization that is biased in a direction that is generally parallel with the ABS, but that is free to move in response to a magnetic field. The biasing of the free layer is provided by a magnetostatic coupling with first and second hard magnetic bias layers 322, 324. One or more seed layers 326 may be provided at the bottom of the sensor stack 302 in order to ensure a desired grain growth of the other layers of the sensor stack 302 deposited thereon. Thin insulation layers 330 is provided at either side of the sensor stack 302 and across at least the bottom lead/shield 304 in order to prevent sense current from being shunted through the magnetic bias layers 322, 324.

It can also be seen in FIG. 3, that the sensor 300 includes a capping layer 334 between the upper surface of the sensor stack 302 and the upper shield 306. The capping layer 332 acts a magnetic separation layer, because it magnetically separates the free layer 312 from the shield 306. The capping layer also protects the layers of the sensor structure 302 from damage during manufacture, such as from the high temperature annealing used to set the magnetization of the pinned layer structure 310. The capping layer 334 can be constructed of a metallic material having a high resistance to a reactive ion etching process that will be used to remove a CMP stop layer (not shown in FIG. 3) as will be described further below. The sensor 300 also includes hard bias capping layers 332 between each of the hard bias layers 322, 324 and the upper shield 306. The hard bias capping layers 332 act as magnetic domain control separation layers, because they separate the hard bias layer 322 from the shield 306. Like the capping layer 334, the hard bias capping layers 332 can be constructed of a metallic material having a high resistance to a reactive ion etching that will be used to remove a hard mask layer, as will be described herein below.

As can be seen, in FIG. 3, the shield 306 has a very flat bottom surface. This is the result of a novel method of manufacturing a magnetic sensor that will be described in detail herein below. In order to better describe the advantages of the present invention with regard to a sensor 300 having an upper shield 306 with a flat bottom interface 336, it is useful to first describe a prior art process and resulting topography on which the shield of such a prior art sensor has been formed.

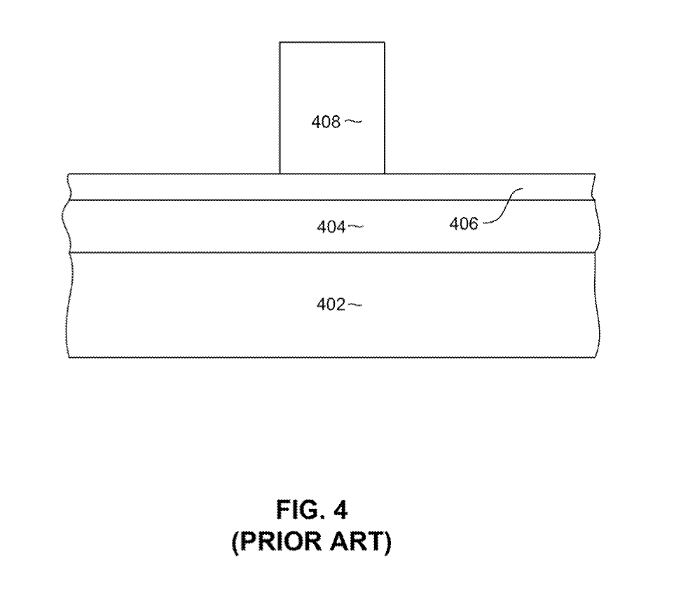

FIGS. 4-9 illustrate a prior art process for manufacturing a magnetic sensor that results in a sensor having a very uneven, non-flat upper shield structure. With particular reference to FIG. 4, a bottom magnetic shield 402 is formed, and a plurality of sensor layers 404 is deposited over the bottom shield 402. A first layer of material that is resistant to chemical mechanical polishing (first CMP stop layer) 406 is deposited over the sensor layers 404. The CMP stop layer 406 can be a material such as diamond like carbon. A mask structure 408 is formed over the hard mask 406. The mask structure 408 includes a photolithographically patterned photoresist layer, but could also include other layers such as an image transfer layer (such as DURIMIDE®), a RIE hard mask, and a Bottom Anti-Reflective Coating (BARC) layer, all of which are not shown for purposes of clarity.

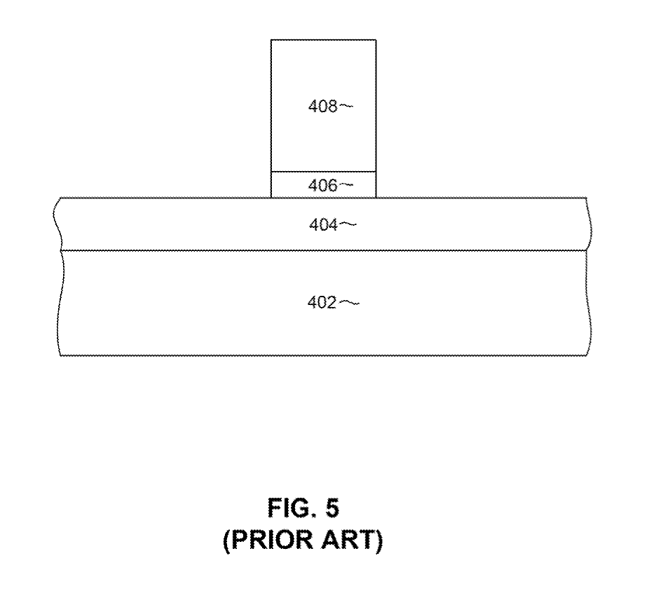

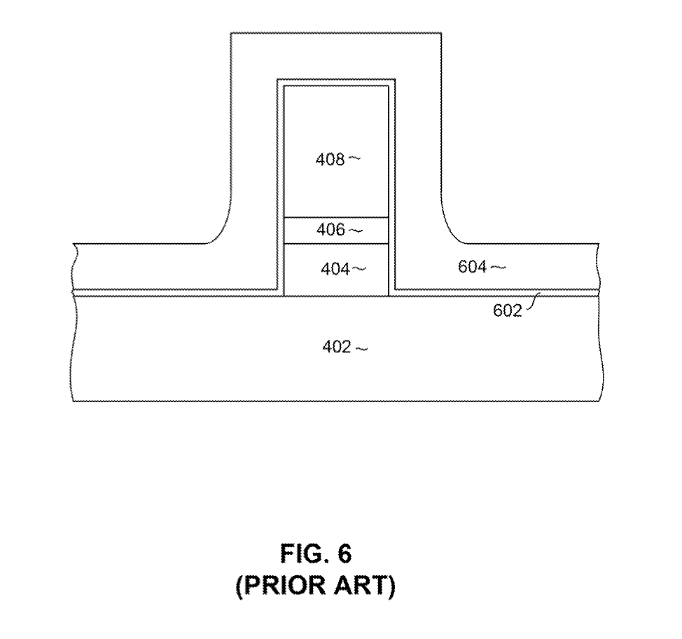

A reactive ion etching is then performed to remove portions of the first CMP stop layer 406 that are not protected by the mask structure 408, leaving a structure as shown in FIG. 5. Then, an ion milling is performed to remove portions of the sensor layers 404 that are not protected by the mask 408 and CMP stop layer 406, thereby defining a sensor structure having a desired width, as shown in FIG. 6.

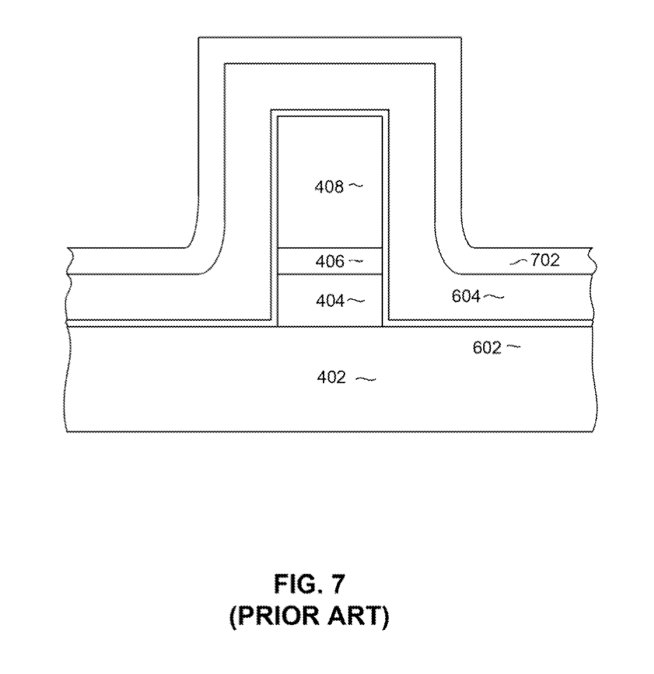

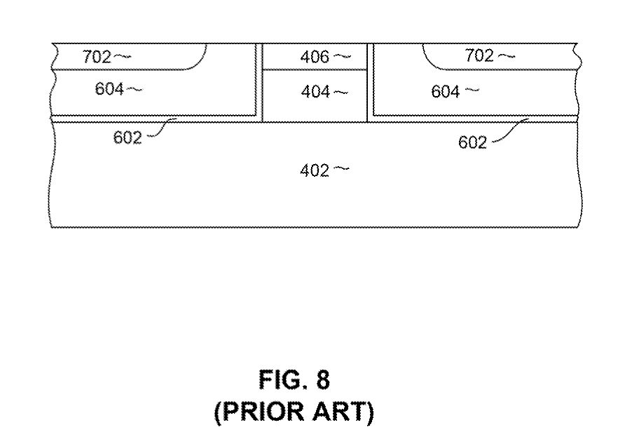

With continued reference to FIG. 6, a thin insulation layer 602 is deposited, followed by a magnetic hard bias material layer 604. Then, as shown in FIG. 7, a second CMP stop layer 702 is deposited. A chemical mechanical polishing process is then performed, leaving a structure as shown in FIG. 8. It can be seen, that the CMP process removes the mask 408 (FIG. 7), but stops at the CMP resistant layers 702, 406. Then, a reactive ion etching is performed to remove the CMP resistant layers 702, 406.

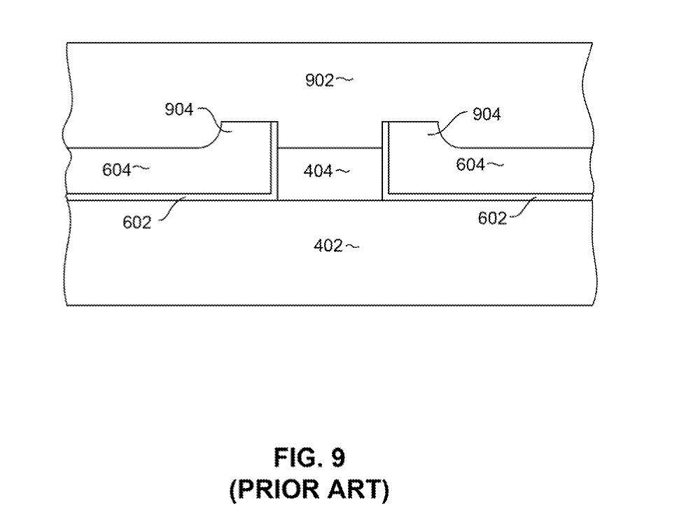

With the CMP stop layers removed, a magnetic material 902 is formed by electroplating to form an upper shield as shown in FIG. 9. As can be seen in FIG. 9, the removal of the CMP stop layers 702, 406 results in the formation of peaks 904 at either side of the sensor stack 404. This, unfortunately, causes the upper shield 902 to have a very non-uniform, non-flat bottom interface, which results in decreased sensor performance and poorly defined gap thickness and corresponding bit length.

Method of the Invention:

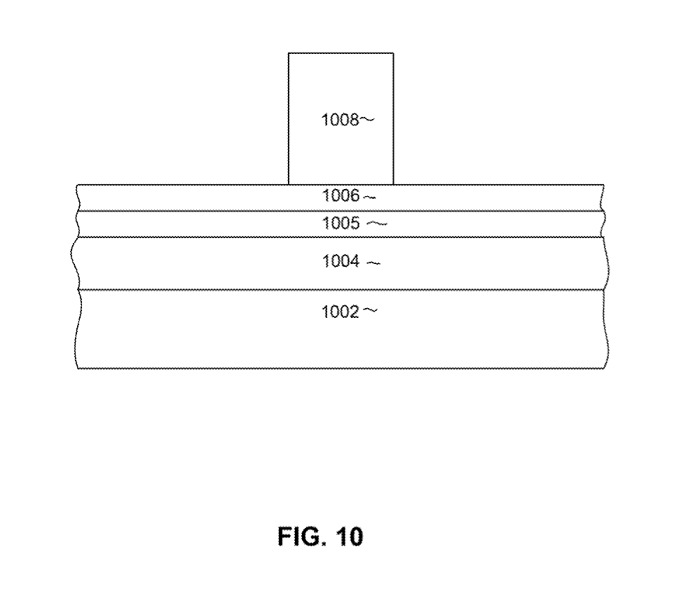

The present invention provides a method for manufacturing a sensor that overcomes this problem, allowing for the formation of a very flat upper shield, as described above with reference to FIG. 3. FIGS. 10-17 illustrate such a method for manufacturing a magnetic sensor according to an embodiment of the invention. With particular reference to FIG. 10 a bottom shield 1002 is formed on a wafer (not shown), and a plurality of sensor layers 1004 is deposited over the bottom shield. The bottom shield can be constructed of NiFe by electroplating. The sensor layers can include a layer of antiferromagnetic material 320, pinned layer structure 310, non-magnetic layer 308 and free layer 312 as described above with reference to FIG. 3. A sensor capping layer 1005 is deposited over the sensor layers 1004, preferably to a thickness of 5-50 nm.

The sensor capping layer 1005 is a magnetic separation layer in that it is a non-magnetic material that magnetically separates the magnetic layers of the sensor layers 1004 from the upper shield (not shown in FIG. 10). A layer of material that is resistant to chemical mechanical polishing (CMP stop layer) 1006 is deposited over the sensor capping layer 1005. The CMP stop layer 1006 can be constructed of diamond like carbon (DLC) or SiC, but alternatively, could be another material such as Ta, Ti, W, Nb, V, Zr, Ir or a metal alloy containing these materials, and preferably has a thickness not greater than 100 nm. A mask structure 1008 is formed over the CMP stop layer 1006. The mask layer 1008 includes a photoresist layer that has been photolithographically patterned to form a mask that defines a sensor width. The mask 1008 could include other layers as well, such as an image transfer layer, RIE mask, and a Bottom Anti-Reflective Coating (BARC).

The sensor capping layer 1005 is preferably constructed of a material that has a higher selectivity for removal by ion milling than the CMP stop layer 1006. Preferably, the capping layer 1005 is constructed of a material that is removed by ion milling at least twice the rate as the CMP stop layer. To this end, the capping layer can be constructed of a metallic material that is any of Zr, Ru, Cr or Al (most preferably Ru) having a high resistance to a reactive ion etching process that can be used to remove the CMP stop layer. If the CMP stop layer is constructed of a material that can be removed by a reactive ion etching in a fluorine-containing gas, then the capping layer 1005 can be a metallic material such as Zr, Ru, Cr, Al or an alloy containing one of these materials. If the CMP stop material 1006 is constructed of a material that can be removed by reactive ion etching in an oxygen containing atmosphere, then the capping layer 1005 can be a metallic material such as Ta, Ir, Ti, Zr, Hf, Cr or Al or an alloy of these materials.

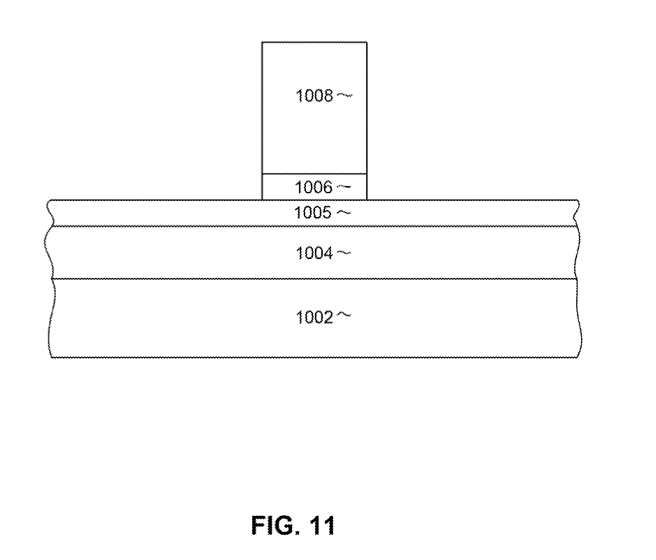

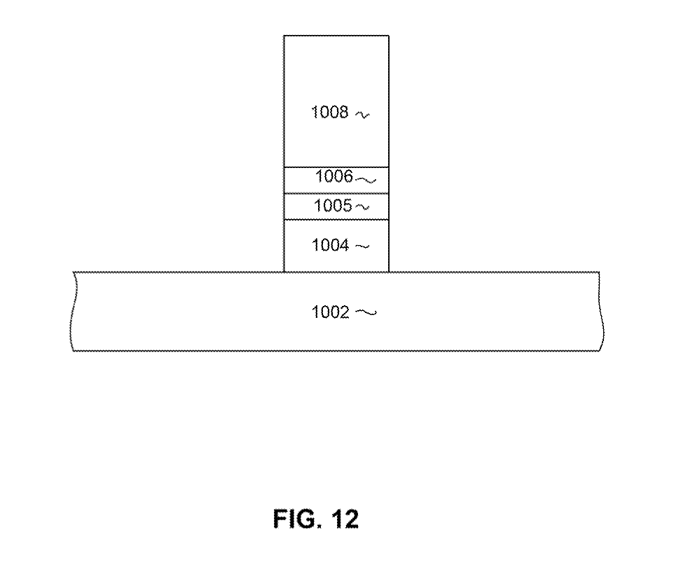

A reactive ion etching is then performed to remove portions of the CMP stop layer 1006 that are not protected by the mask, leaving a structure as shown in FIG. 11. The capping layer 1005 is highly resistant to removal by the reactive ion etching used to remove exposed portions of the CMP stop layer 1006, and therefore, remains substantially intact after the reactive ion etching. For example, if the CMP stop layer 1006 is SiC a fluorine RIE can be used to remove it, and the capping layer 1005 can be Ru. Then, an ion milling is performed to remove portions of the capping layer 1005 and sensor layers 1004 that are not protected by the mask 1008 and CMP stop layer 1006, leaving a structure as shown in FIG. 12.

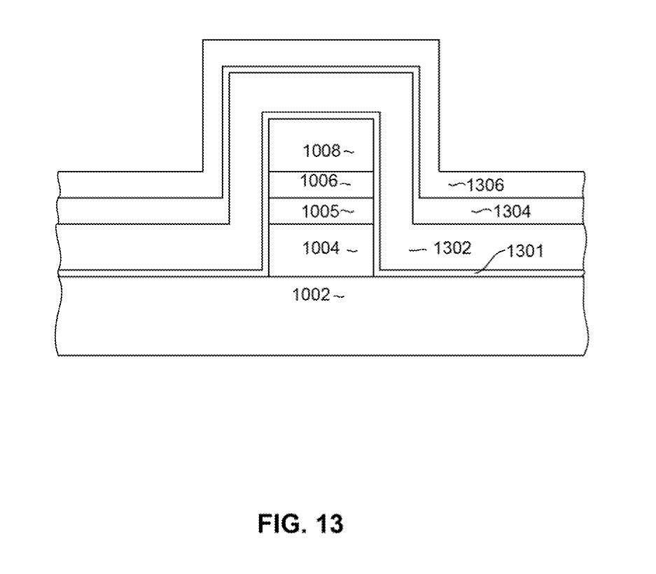

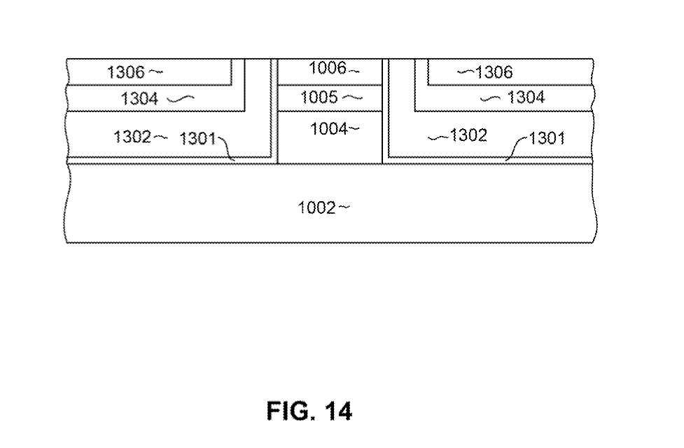

With reference now to FIG. 13, a thin, non-magnetic, electrically insulating layer such as alumina (Al₂O₃) 1301 is deposited, preferably by a conformal deposition process such as atomic layer deposition. The insulation layer 1301 can be deposited to a thickness of about 1-10 nm or about 1.5 nm. A layer of magnetic material such as CoPt or CoPtCr 1302 is deposited to provide magnetic domain control for hard magnetic biasing of the free layer (312 in FIG. 3). This layer 1302, referred to herein as a hard bias layer, can be deposited to a thickness of 5-100 nm or about 13 nm and can be deposited using long-throw sputtering which offers excellent linearity. A hard bias capping layer 1304 is deposited over the hard magnetic bias layer 1302. The hard bias capping layer 1304 is a magnetic domain bias separation layer for magnetically separating the hard bias layer 1304 from the upper shield (306 in FIG. 3). A second CMP stop layer 1306 is then deposited over the hard bias capping layer 1304. The second CMP stop layer 1306 can be constructed of the same material as the first CMP stop layer 1006, and is preferably deposited to about the same thickness. Then, a chemical mechanical polishing process is performed to remove the mask 1008, stopping at the CMP stop layers 1306, 1006 and leaving a structure as shown in FIG. 14.

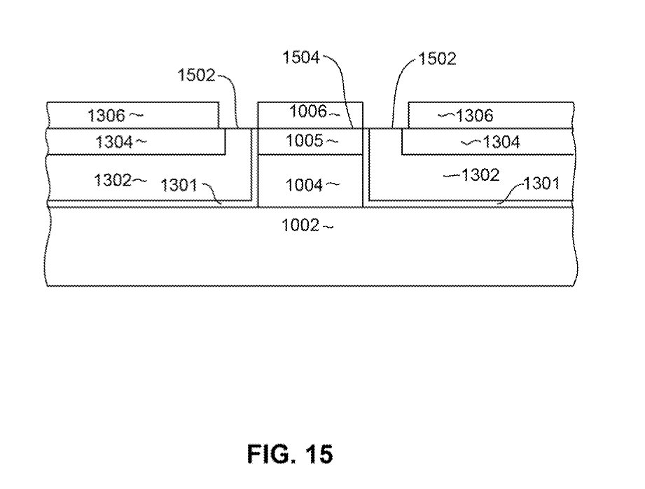

At this point an ion milling is performed to etch back portions of the layers 1302, 1304 that are not protected by the CMP stop layers, leaving a structure as shown in FIG. 15. To facilitate this etch back, the hard bias layer 1302 and hard bias capping layer 1304 are preferably constructed of materials that have a higher selectivity for removal by ion milling than the CMP stop layer. The CMP stop layers 1006, 1306 are preferably made of a material that has at least twice the resistance to ion milling in terms of selectivity as the hard bias layer 1302 and hard bias capping layer 1304. In this way, while the CMP stop layers 1006, 1306 may be slightly removed by the ion milling used to etch back the layers 1302, 1304, the CMP stop layers 1006, 1306 remain substantially intact during the ion milling to protect the layers there-beneath. To this end, the CMP stop layers 1306, 1006 can each be constructed of Ta, Ti, W, Nb, V, Zr, Jr or an alloy, oxide or nitride containing these metals. The CMP stop layers 1306, 1006 can also be constructed of SiC, SiN, or Diamond Like Carbon (DLC

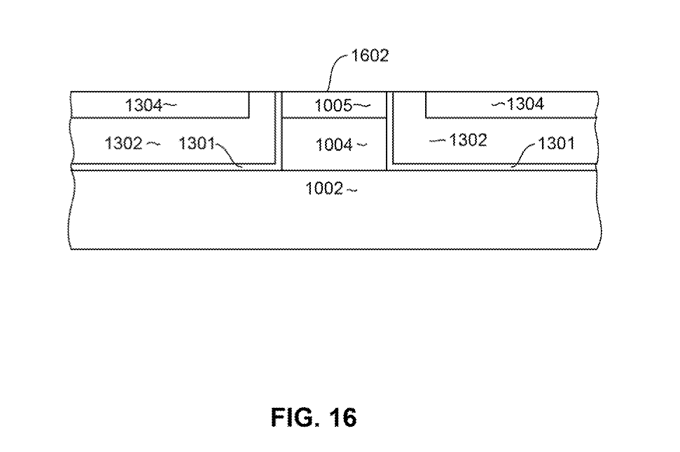

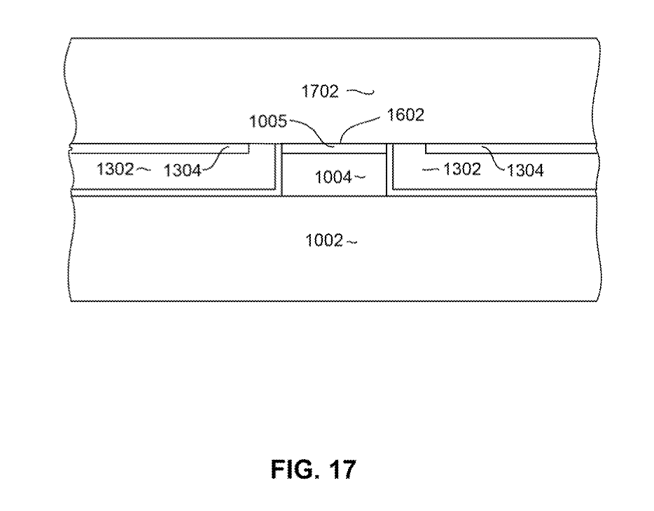

The ion milling used to etch back the layers 1302, 1304 is preferably performed to such an extent that the layers 1302, 1304 have an exposed surface 1502 that is substantially coplanar with an upper surface or interface 1504 of the capping layer 1005. Then, after the layers 1302, 1301 have been etched back by the ion milling, a reactive ion etching is performed to remove the remaining CMP stop layers 1306, 1006, leaving a structure such as that shown in FIG. 16. As can be seen in FIG. 16, this leaves a substantially planar upper surface 1602 with at least a portion of the sensor capping layer 1005 and hard bias capping layer 1304 remaining intact. Then, with reference to FIG. 17, an upper magnetic shield 1702 is formed on top of the planar upper surface 1602. The magnetic shield 1702 can be formed by electroplating, by: first depositing a seed layer (not shown); forming an electroplating frame mask (also not shown); electroplating a magnetic material into the electroplating frame mask; removing the electroplating frame mask; and performing a quick ion milling to remove the portions of the seed layer that extend beyond the electroplated shield.

As can be seen, the above described process results in a magnetic shield 1702 that has a smooth, flat bottom interface. This smooth, flat bottom interface improves read gap definition for increased data density.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A method for manufacturing a magnetic sensor, comprising:
forming a first magnetic shield;
depositing a plurality of sensor layers over the first magnetic shield;
depositing a non-magnetic sensor capping layer over the plurality of sensor layers;
depositing a first CMP stop layer over the non-magnetic sensor capping layer;
forming a mask structure over first CMPS stop layer;
performing a first reactive ion etching to transfer the image of the mask onto the underlying first CMP stop layer;
performing a first ion milling to transfer the image of the mask and CMP stop layer onto the underlying plurality of sensor layers;
depositing a hard magnetic bias layer;
depositing a second CMP stop layer;
performing a chemical mechanical polishing;
performing a second ion milling to remove portions of the hard magnetic bias layer that are not protected by the first and second CMP stop layers; and
performing a second reactive ion etching to remove the first and second CMP stop layers.

2. The method as in claim 1 wherein the sensor capping layer has an upper surface and wherein the second ion milling is performed until the portion of the hard bias layer that is not protected by the first and second CMP stop layers is formed with a surface that is substantially coplanar with the upper surface of the sensor capping layer.

3. The method as in claim 1 wherein the sensor capping layer comprises Ru, Zr, Cr, Ta, Ir, Ti, Hf, Al or an alloy containing one or more of these materials.

4. The method as in claim 1 wherein the first and second CMP stop layers each comprise diamond like carbon, SiC, Ta, Ti, W, V, Zr or Ir.

5. The method as in claim 1 wherein the first and second CMP stop layers are each constructed of a material that can be removed by reactive ion etching in a fluorine atmosphere and the sensor capping layer comprises Zr, Ru, Cr or Al.

6. The method as in claim 1 wherein the first and second CMP stop layers are each constructed of a material that can be removed by reactive ion etching in an oxygen atmosphere and the sensor capping layer comprises Ta, Ir, Ti, Zr, Hf, Cr or Al.

7. The method as in claim 1 wherein the hard magnetic bias layer has a higher selectivity to removal by ion milling than the first and second CMP stop layers.

8. The method as in claim 1 wherein the first and second CMP stop layers are each constructed of a material that has at least twice at high a resistance to removal by ion milling than that of the magnetic hard bias layers.

9. The method as in claim 1 wherein the sensor capping layer has a thickness of 5-50 nm.

10. The method as in claim 1 wherein the first and second CMP stop layers are each constructed of a material having a high resistance to removal by chemical mechanical polishing.

11. The method as in claim 1 wherein the first and second CMP stop layers each have a thickness of no more than 100 nm.

12. The method as in claim 1 wherein the second ion milling is performed after the chemical mechanical polishing and before the second reactive ion etching.

13. A method for manufacturing a magnetic sensor, comprising:
forming a first magnetic shield;
depositing a plurality of sensor layers over the first magnetic shield;
depositing a non-magnetic sensor capping layer over the plurality of sensor layers;
depositing a first CMP stop layer over the non-magnetic sensor capping layer;
forming a mask structure over first CMPS stop layer;
performing a first reactive ion etching to transfer the image of the mask onto the underlying first CMP stop layer;
performing a first ion milling to transfer the image of the mask and CMP stop layer onto the underlying plurality of sensor layers;
depositing a thin insulation layer;
depositing a hard magnetic bias layer over the thin insulation layer;
depositing a hard magnetic bias capping layer over the hard magnetic bias layer;
depositing a second CMP stop layer over the hard magnetic bias capping layer;
performing a chemical mechanical polishing;
performing a second ion milling to remove portions of the insulation layer, hard magnetic bias layer and hard magnetic bias capping layer that are not protected by the first and second CMP stop layers; and
performing a second reactive ion etching to remove the first and second CMP stop layers.

14. The method as in claim 13 wherein the first and second CMP stop layers are each constructed of a material having a high resistance to removal by chemical mechanical polishing.

15. The method as in claim 13 wherein the sensor capping layer has an upper surface and wherein the second ion milling is performed until the portion of the insulation layer, hard bias layer and hard bias capping layer that are not protected by the first and second CMP stop layers is formed with a surface that is substantially coplanar with the upper surface of the sensor capping layer.

16. The method as in claim 13 wherein the sensor capping layer and the hard magnetic bias capping layer each comprise Ru, Zr, Cr, Ta, Ir, Ti, Hf, Al or an alloy containing one or more of these materials.

17. The method as in claim 13 wherein the first and second CMP stop layers each comprise diamond like carbon, SiC, Ta, Ti, W, V, Zr or Ir.

18. The method as in claim 13 wherein the first and second CMP stop layers are each constructed of a material that can be removed by reactive ion etching in a fluorine atmosphere and the sensor capping layer and hard magnetic bias capping layer each comprise Zr, Ru, Cr or Al.

19. The method as in claim 13 wherein the first and second CMP stop layers are each constructed of a material that can be removed by reactive ion etching in an oxygen atmosphere and the sensor capping layer and the hard magnetic bias caping layer each comprise Ta, Ir, Ti, Zr, Hf, Cr or Al.

20. The method as in claim 13 wherein the first and second CMP stop layers are each constructed of a material that has at least twice as high a resistance to removal by ion milling than that of the magnetic hard bias layers, insulation layer and hard magnetic bias capping layer.

21. The method as in claim 13 wherein the second ion milling is performed after the chemical mechanical polishing and before the second reactive ion etching.
